(19) United States
(12) Patent Application Publication
(10) Pub. No.: US 2021/0004696 A1
(43) Pub. Date: Jan. 7, 2021

(54) SYSTEM AND METHOD FOR AUTOMATIC SECURE DELIVERY OF MODEL

(71) Applicant: BEIJING BAIDU NETCOM SCIENCE AND TECHNOLOGY CO., LTD., Beijing (CN)

(72) Inventors: Haitao LIN, Beijing (CN); Jianxia LIU, Beijing (CN); Wenkang ZHANG, Beijing (CN); Baolong NIU, Beijing (CN); Hongguang ZHANG, Beijing (CN); Qingyun SONG, Beijing (CN); Youping YU, Beijing (CN); Tian WU, Beijing (CN)

(21) Appl. No.: 16/895,350

(22) Filed: Jun. 8, 2020

(30) Foreign Application Priority Data
Jul. 3, 2019 (CN) 201910592989.2

(51) Int. Cl. G06N 5/04; G06F 21/14; G06F 21/60; G06N 20/00

(52) U.S. Cl. CPC G06N 5/04; G06F 21/14; G06F 2221/0724; G06N 20/00; G06F 21/602

(57) ABSTRACT

The present disclosure provides a system and a method for automatic secure delivery of a model, and belongs to the field of delivery technologies of artificial intelligence models. The system includes: a model warehouse, including at least one machine learning model; a prediction warehouse, including at least one prediction module matching metadata of the machine learning model in the model warehouse; and a processing engine, configured to have a function of assembling the machine learning model in the model warehouse and the prediction module in the prediction warehouse; in which the prediction module is configured to have an authentication function and an anti-debugging function, and the processing engine is configured to assemble the machine learning model in the model warehouse and the prediction module in the prediction warehouse which have a metadata matching relationship, and to generate a prediction service after the assembly is completed.

### CROSS-REFERENCE TO RELATED APPLICATION

This application claims a priority to and benefits of Chinese Patent Application No. 201910592989.2, filed on Jul. 3, 2019, the entire content of which is incorporated herein by reference.

### FIELD

The present disclosure relates to the field of delivery technologies of artificial intelligence models, and more particularly, to a method for establishing a prediction module, a method for automatically generating a prediction service, and a system for automatically generating a prediction service.

### BACKGROUND

With the rapid development of artificial intelligence technologies, artificial intelligence (AI) has entered a large-scale commercial stage. Artificial intelligence delivery models include a plurality of delivery models such as public cloud, dedicated cloud, and private cloud. Public cloud outputs AI capabilities by providing an online application programming interface (API). Although users can only call the API to make predictions as they cannot see key parameters of the model and environment variables, a relatively independent prediction service fails to be realized, and thus practical application requirements of higher security and privatization cannot be met. Dedicated cloud, which is a dedicated cloud resource pool that provides physical isolation of computing and storage for users, deploys AI services and application data on dedicated resources. Private cloud is an independent computer room and server of users, which has relatively high data and server security as it independently runs, maintains, and deploys AI services.

Regarding the two delivery modes of dedicated cloud and private cloud, for demands of using or developing AI services, users need to ensure the security and confidentiality of models and application services, such as anti-cracking, anti-replication, and anti-override use. Furthermore, quick auto-delivery features are necessary, and easy deployment, testing and using features are also necessary.

### SUMMARY

Embodiments of the present disclosure provide a method for establishing a prediction module. The method includes S1) forming a prediction component that matches metadata of a machine learning model, and S2) acquiring a security component, and integrating the security component and the prediction component to obtain the prediction module.

Embodiments of the present disclosure provide a method for automatically generating a prediction service. The method includes S1) selecting a machine learning model and acquiring interface configurations of the machine learning model, and S2) selecting a prediction module adapted to the machine learning model based on metadata of the machine learning model, updating the prediction module in combination with the interface configurations, and assembling the machine learning model and the prediction module to generate the prediction service.

Embodiments of the present disclosure provide a system for automatically generating a prediction service. The system includes: a model warehouse, including at least one machine learning model; a prediction warehouse, including at least one prediction module matching metadata of the machine learning model in the model warehouse; and a processing engine, configured to have a function of assembling the machine learning model in the model warehouse and the prediction module in the prediction warehouse. The prediction module is configured to have an authentication function and an anti-debugging function. The processing engine is configured to assemble the machine learning model in the model warehouse and the prediction module in the prediction warehouse which have a metadata matching relationship, and to generate the prediction service after the assembly is completed.

Other features and advantages of the embodiments of the present disclosure will be described in detail in the following Detailed Description.

### BRIEF DESCRIPTION OF THE DRAWINGS

The accompanying drawings are used to provide a further understanding of the embodiments of the present disclosure, and constitute a part of the description. The accompanying drawings are used to explain the embodiments of the present disclosure together with the following specific implementations, but do not constitute a limitation on the embodiments of the present disclosure.

FIG. 1 is a flowchart of an automatic generation of a prediction service according to embodiments of the present disclosure.

FIG. 2 is a schematic diagram of main modules of a prediction service according to embodiments of the present disclosure.

FIG. 3 is a flowchart of a compilation and reinforcement process of a prediction service in a generation process according to embodiments of the present disclosure.

FIG. 4 is a flowchart of an encryption and decryption process of a machine learning model when a prediction service is running according to embodiments of the present disclosure.

FIG. 5 is a schematic diagram of an interactive architecture for implementing a prediction service and an online authentication service in a dedicated cloud according to embodiments of the present disclosure.

FIG. 6 is a schematic diagram of an interactive architecture for implementing a prediction service and an online authentication service in a private cloud according to embodiments of the present disclosure.

### DETAILED DESCRIPTION

The specific implementations of embodiments of the present disclosure will be described in detail below with reference to the accompanying drawings. It should be understood that the specific implementations described herein are only used to illustrate and explain the embodiments of the present disclosure, and are not intended to limit the embodiments of the present disclosure.

### Embodiment 1

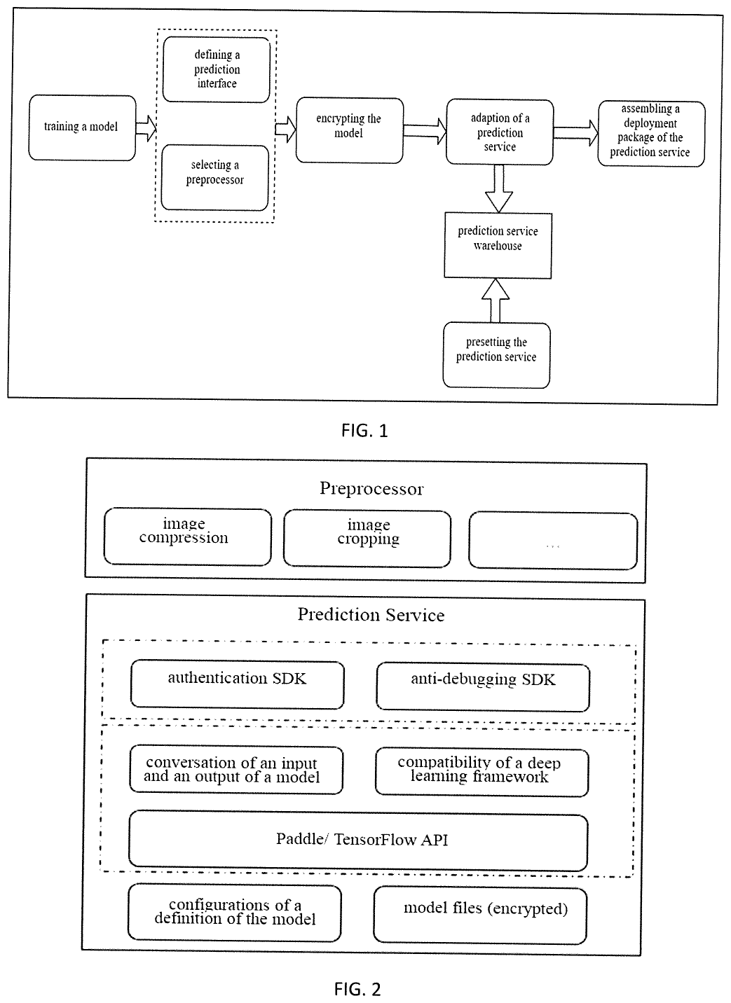

As illustrated in FIG. 1, this embodiment provides a method for establishing a prediction module. The method includes: S1) forming a prediction component that matches metadata of a machine learning model; and S2) acquiring a security component, and integrating the security component and the prediction component to obtain the prediction module.

In detail, the prediction component in S1) includes a calling component and an execution component. Functions of the execution component include a request function and a receiving function. The request function is to send, through a function of the calling component, data for an input of the machine learning model to the machine learning model for calculation. The receiving function is to receive, through a function of the calling component, output data calculated by the machine learning model. Functions of the calling component include an encapsulation function and a decapsulation function. The encapsulation function is to encapsulate a format of the data for the input of the machine learning model into a format of data having configurations of a prediction interface. The decapsulation function is to decapsulate the output data calculated by the machine learning model.

The machine learning model may be a deep learning model with an application programming interface, such as PaddlePaddle, Tensorflow, and so on. The metadata of the machine learning model includes model information, such as framework types of the deep learning models, classes of processors or graphics processors, classifications of driver versions of graphics processors and classes of development languages (Python, C, C++, GO, Java, etc.).

The calling component may be designed with the encapsulation function and decapsulation function based on the application programming interface of the machine learning model, and needs to interact the input and output data transmitted by corresponding functions of the prediction component with the machine learning model, such as setting the configurations of the prediction interface in a manner that the configurations of the prediction interface realize pass-through of parameters without exposing specific commands or parameters of the model. The actual type of the calling component needs to be determined based on the production environment of the user of the delivery, which may be a code file, an execution file, and a link file. The prediction component may be a code file, an execution file, a link file, and so on. Integration means may be compilation, parameter passing, and placing in a production environment with shared object files to support operation, and the like.

In detail, acquiring the security component in S2) includes selecting and configuring an authentication component and an anti-debugging component, and integrating the authentication component and the anti-debugging component into the security component.

The authentication component may be provided with a client corresponding to a server of an authentication device in an authentication interaction network, and may be an integrated software development kit (SDK). The anti-debugging component may be integrated with the authentication component in the software development kit, and includes a debugging monitoring sub-component and an anti-debugging execution component. Functions of the debugging monitoring sub-component may be real-time monitoring of parameters of the production environment where the prediction service is performed and the log of the prediction service, etc. The anti-debugging execution component may determine whether to trigger a debugging state based on a preset strategy and an output result corresponding to the debugging monitoring sub-component, and optionally perform operations such as interrupting or suspending the prediction service, as illustrated in FIG. 2.

In detail, before obtaining the prediction module in S2), the method includes acquiring the security component, acquiring a decryption component matching pre-encryption of the machine learning model, and integrating the decryption component, the security component, and the prediction component to integrate the decryption capability of the model, thereby achieving the ability to load and decrypt an encrypted model at runtime.

In detail, after integrating the security component and the prediction component, and before obtaining the prediction module, the method further, includes obtaining an integrated component, performing obfuscated compilation on the integrated component, obtaining an execution file after the obfuscated compilation is completed, and packing the execution file.

As illustrated in FIG. 3, based on the specific production environment, after executing the obfuscated compilation, an executable and linkable format (ELF) file may be generated, and then the ELF file is packed, so that the prediction module has sufficient security, and anti-decompilation, anti-disassembly analysis and anti-dynamic analysis features.

In detail, integrating the security component and the prediction component to obtain the prediction module in S2) includes setting an execution rule, and integrating the security component and the prediction component in combination with the execution rule to obtain the prediction module. The prediction module is configured to, based on an execution result of a function corresponding to the security component, selectively execute a function corresponding to the prediction component in combination with the execution rule.

The execution rule may be set, after an activation of a function module corresponding to the security component, based on an output result of the function module. For example, the execution rule is set as interrupting the prediction module when the output result of the function module is that there is a debugging behavior.

### Embodiment 2

This embodiment provides a method for automatically generating a prediction service. The method includes S1) selecting a machine learning model and acquiring interface configurations of the machine learning model, and S2) selecting a prediction module adapted to the machine learning model based on metadata of the machine learning model, updating the prediction module in combination with the interface configurations, and assembling the machine learning model and the prediction module to generate the prediction service.

In detail, S1) includes S101) acquiring machine learning models to be trained with different types of metadata, training each machine learning model to be trained, defining interface configurations of each machine learning model to be trained, obtaining a set of pre-trained machine learning models after training is completed, and storing the set of pre-trained machine learning models in a model warehouse, and S102) selecting a machine learning model from the model warehouse, and acquiring interface configurations of the machine learning model.

The interface configurations may be configured to the pass-through parameters and results of the prediction service. When the prediction service runs, parameters of the prediction interface in the calling component are converted based on the interface configurations and passed to the machine learning model.

In detail, after acquiring the machine learning models to be trained with different types of metadata, and before defining the interface configurations of each machine learning model to be trained, the method further includes configuring a preprocessor for each machine learning model to be trained. The preprocessor is configured to selectively change data for an input of the machine learning model to be trained based on a first preset rule, and to obtain data that meets input data requirements of the machine learning model to be trained after the change is completed. The first preset rule may be configured to provide a determination strategy and a modification manner for the data input into the machine learning model to be trained.

In detail, storing the set of pre-trained machine learning models in the model warehouse in S101) includes pre-encrypting each pre-trained machine learning model in the set of pre-trained machine learning models, obtaining a set of pre-trained machine learning models with pre-encryption after the pre-encryption is completed, and storing the set of pre-trained machine learning models with pre-encryption in the model warehouse.

Encryption algorithms, including AES (Advanced Encryption Standard) encryption algorithm and RSA encryption algorithm, may be preset.

In detail, S102) further includes selecting a preprocessor based on the machine learning model.

The preprocessor is configured to selectively change data for an input of the machine learning model based on a second preset rule, and to obtain data that meets input data requirements of the machine learning model after the change is completed. The second preset rule may be configured to provide a determination strategy and a modification manner for the data input into the machine learning model.

Selecting a preprocessor may refer to adding a preprocessor or selecting a preprocessor from a preset plug-in warehouse, such as image compression and cropping, etc., to meet personalized needs of the machine learning model. The preset plug-in warehouse may have preprocessors and other auxiliary plug-ins, which may be, for example, a user interface plug-in for displaying the input and output data.

In detail, before updating the prediction module in combination with the interface configurations in S2), the method includes S201) establishing prediction modules corresponding to the machine learning models to be trained or pre-trained machine learning models in the set of pre-trained machine learning models, and storing all the prediction modules in a prediction warehouse, and S202) selecting the prediction module adapted to the machine learning model from the prediction warehouse based on the metadata of the machine learning model.

In detail, establishing the prediction module in S201) includes establishing the prediction module by an authentication component and an anti-debugging component.

In detail, the prediction service in S2) has a decryption function that matches the pre-encryption of the machine learning model.

In detail, assembling the machine learning model and the prediction module to generate the prediction service in S2) includes assembling the machine learning model and the prediction module to generate a deployment piece of the prediction service, and installing the deployment piece in a production environment to generate an execution body of the prediction service in the production environment.

The prediction warehouse and model warehouse use a file storage system to store files, and use a relational database to implement indexing. The relational database is configured to store description information of the prediction module and the machine learning model, and also to store locations of files corresponding to the prediction module and the machine learning model in the file system, thereby forming index data. When performing a matching query, first the index data is obtained from the relational database for calculation, and then a matched file in a corresponding file system is retrieved. The model warehouse may also store machine learning models to be trained for the reason that the user may need to use custom sample data to form a specific pre-trained machine learning model. The prediction warehouse stores abundant prediction services, so that the user only needs to specify and provide several pieces of metadata for the machine learning model to determine the machine learning model and prediction service for assembly. The deployment piece may be generated based on the production environment of the user. For example, when the Linux system environment is the production environment, the deployment piece may be a deployment code segment used to install the prediction service, which may be obtained by using, for example, a cURL syntax command, so that the environment where the user is may automatically and quickly install the prediction service.

### Embodiment 3

This embodiment provides a method for using a prediction service. The method includes S1) after activating a prediction service in a production environment, acquiring an authorization state corresponding to an authentication function in the prediction service, and S2) in response to the authorization state meeting preset authentication conditions, decrypting a machine learning model of the prediction service in the production environment, acquiring input data, transmitting the input data to the machine learning model for calculation through an execution function and a calling function of the prediction service, and obtaining, through the execution function and the calling function, output data and/or an output state calculated, based on the input data, by the machine learning model.

In detail, S1) and/or S2) further include acquiring a debugging state corresponding to an anti-debugging function in the prediction service, and selectively activating a preset protection function in the prediction service based on a relationship between the debugging state and a preset debugging condition.

The prediction service has a high level of security, which is suitable for scenarios in which AI models are delivered by dedicated and private clouds, and provides security capabilities related to operation of authentication control, anti-tracking debugging, decompilation, and anti-cracking of a model. Second, the integration cost is low. After the training on the model is completed, the user only needs to configure configurations of the definition of the prediction interface, and automatic encryption of the model may be realized by selecting a corresponding preprocessor. After that, the universal prediction service that supports model prediction may be automatically adapted, and finally an installation package is assembled. Also, there is no additional cost during model iteration. Third, full automation has good compatibility performance and is compatible with mainstream deep learning model frameworks in the industry. The deep learning model frameworks include PaddlePaddle, Tensorflow, caffe, and so on.

### Embodiment 4

This embodiment provides a system for automatically generating a prediction service. The system includes: a model warehouse, a prediction warehouse and a processing engine.

The model warehouse includes at least one machine learning model.

The prediction warehouse includes at least one prediction module matching metadata of the machine learning model in the model warehouse.

The processing engine is configured to have a function of assembling the machine learning model in the model warehouse and the prediction module in the prediction warehouse.

The prediction module is configured to have an authentication function and an anti-debugging function. The processing engine is configured to assemble the machine learning model in the model warehouse and the prediction module in the prediction warehouse which have a metadata matching relationship, and to generate the prediction service after the assembly is completed.

The system also includes the plug-in warehouse. The plug-in warehouse includes a preprocessor, which supports customization of input parameters of the model and completes the preprocessing, such as image compression and cropping.

The prediction module in the prediction warehouse may be updated or deleted corresponding to the machine learning model, or a new prediction module may be added based on the method of Embodiment 1.

The machine learning models in the model warehouse may be updated or deleted, or a new machine learning model may be added based on the method of Embodiment 2.

The system further includes a production environment warehouse. The production environment warehouse includes a production environment for supporting an execution of the prediction service. The production environment may be, for example, a cloud server environment and a container environment.

The processing engine is further configured to assemble a selected current prediction service and a production environment supporting the current prediction service to generate a deployment mirror. The deployment mirror may be installed or restored in a system environment or a container environment, may significantly increase the speed of deployment, and simplifies deployment process relative to the selection of the user.

The prediction module implements the authentication function through an authentication SDK. The authentication SDK enables the prediction service to have the ability to control operation permissions, supports multi-dimensional control such as validity period, products and resources (instances/query rate per second), and may be connected to online or offline authentication services.

As illustrated in FIG. 5, in a dedicated cloud scenario, the online authentication mode is adopted. The prediction service requests the online authentication service on the public cloud through the authentication SDK, and responds to an authorization response to selectively perform permission control on dimensions such as validity period, products and resources.

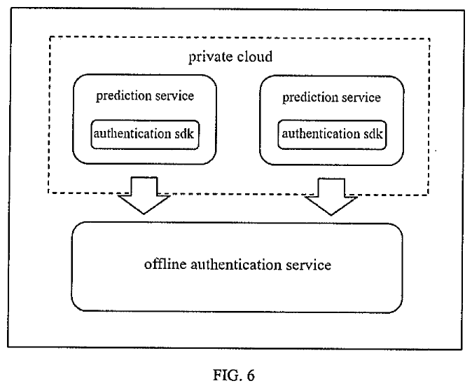

As illustrated in FIG. 6, in a private cloud scenario, the offline authentication mode is adopted. The prediction service requests the offline authentication service on the private cloud through the authentication SDK, and responds to an authorization response to selectively perform permission control on dimensions such as validity period, products and resources.

The prediction module implements an anti-debugging function through an anti-debugging SDK. The anti-debugging SDK enables the prediction service to have abilities such as dump analyses to prevent file backup performed by a memory, and anti-tracking debugging, and improves the security of the prediction service.

The prediction service integrates the authentication SDK and anti-debugging SDK with coding, such that the prediction service has security capabilities of permission control and anti-debugging attacks. The prediction service is obtained through obfuscated compilation in advance, which improves security capabilities of anti-decompilation. Packing and reinforcing ELF files such as executable programs improve security capabilities of anti-disassembly analysis or anti-dynamic analysis.

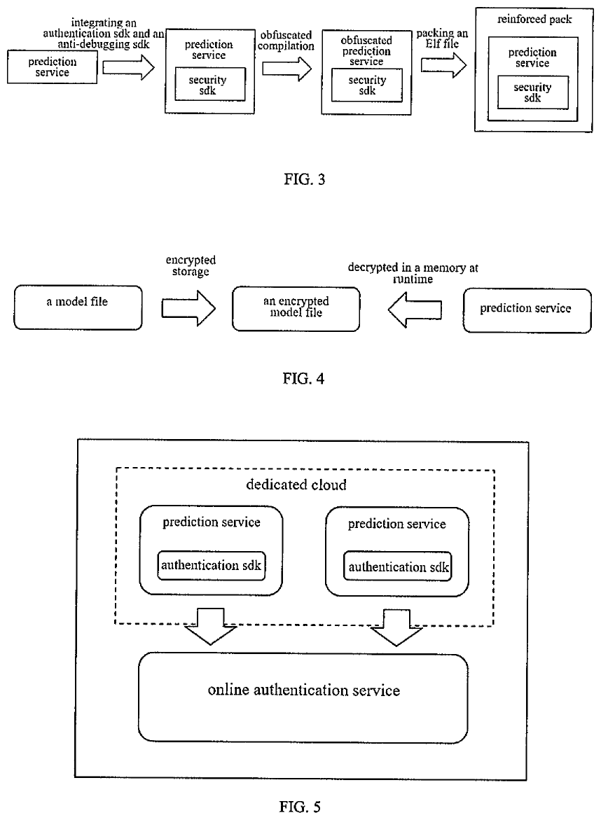

As illustrated in FIG. 4, the machine learning models in the model warehouse are all pre-encrypted, and encrypted files are downloaded directly when used. When the processing engine drives the prediction service, the encrypted model files are loaded and decrypted in memory to prevent data plaintexts from being exposed, and to improve the security of the model files.

The prediction module includes the prediction component and the calling component. The service formed by the prediction component in the prediction module is a universal prediction service. The universal prediction service implements model loading and prediction based on APIs of deep learning model frameworks, such as PaddlePaddle and Tensorflow. When the universal prediction service is running, the model file is decrypted and loaded in the dynamic memory and a unified prediction interface is encapsulated. The calling component may provide customizable input and output parameter configurations based on the interface configurations of the deep learning model framework adopted, and perform parameter transfer and processing on the format of a result to achieve the universality of the prediction service. The calling component has the ability to adapt to any machine learning model with an application program interface.

Corresponding to the above, the present disclosure introduces the security component. The functions corresponding to the security component are to protect the use of the functions corresponding to the prediction component and the use of a model.

The present disclosure provides a structure of the prediction component for realizing the security and confidentiality of the model. If a user needs to directly operate on an input and output of the model, on the one hand, the model is exposed and files or configurations of the model are extremely easy to be obtained; and on the other hand, difficulties in delivery, use, and deployment are produced as not all users are familiar with input and output definitions and functional features of each model. Consequently, realizing the isolation and relatively uniform input and output forms of data transmission by the prediction component may guarantee the security and privacy of the model.

The present disclosure provides a structure of the security component for realizing the security and confidentiality of the model. The authentication component may be configured to request whether a user is authorized and may further distinguish permissions to determine functional items that the user may operate. The anti-debugging component may be configured for anti-tracking debugging.

The present disclosure provides the decryption component for decrypting a model file under secure conditions.

The present disclosure realizes the anti-compilation capability, anti-disassembly analysis capability and anti-reverse dynamic analysis capability of the prediction module.

The present disclosure may flexibly set the use of the functions of the prediction component through the execution rule.

The present disclosure provides an automated quick delivery method, which quickly adapts the prediction module based on the metadata of the selected machine learning model, and generates the prediction service by assembling the prediction module and the machine learning model, that is, the delivery is completed.

In the present disclosure, the machine learning model used for prediction service generation is trained in advance, and stored and encrypted in the model warehouse, thereby greatly improving the delivery speed.

In the present disclosure, each machine learning model to be trained is provided with a preprocessor, which may effectively process sample data used for training to meet data requirements.

The present disclosure configures a preprocessor for the machine learning model generated by the prediction service, thereby effectively and flexibly processing data used for the input of the model to meet data requirements.

After generating the prediction service, the present disclosure provides a deployment form of the prediction service based on the production environment, which increases system flexibility and speeds up deployment speed.

The present disclosure provides a secure and confidential operation mode of the prediction service.

After the system based on the present disclosure enters production, the system may quickly and automatically deliver the prediction service featuring security and confidentiality based on needs of users.

The optional implementations of the embodiments of the present disclosure have been described in detail above with reference to the accompanying drawings. However, the embodiments of the present disclosure are not limited to specific details in the foregoing implementations. Within the scope of the technical concept of the embodiments of the present disclosure, various simple modifications may be made to the technical solution of the embodiments of the present disclosure, and these simple modifications belong to the protection scope of the embodiments of the present disclosure.

In addition, it should be noted that the specific technical features described in the foregoing specific embodiments can be combined in any suitable manner without conflict. In order to avoid unnecessary repetition, the embodiments of the present disclosure do not separately describe various possible combinations.

Those skilled in the art may understand that all or part of the steps in the method of the above embodiments can be completed by a program instructing related hardware. The program is stored in a storage medium and includes several instructions to instruct a single-chip microcomputer, a chip or a processor to execute all or part of the steps of the method described in each embodiment of the present disclosure. The aforementioned storage medium includes: a USB disk, a mobile hard disk, a read-only memory (ROM), a random-access memory (RAM), a magnetic disk, an optical disk, or other media that can store program codes.

In addition, various combinations of the embodiments of the present disclosure can also be arbitrarily combined, and should also be regarded as contents disclosed by the embodiments of the present disclosure as long as the combinations do not violate the concept of the embodiments of the present disclosure.

What is claimed is:

1. A method for establishing a prediction module, comprising:
S1) forming a prediction component that matches metadata of a machine learning model; and
S2) acquiring a security component, and integrating the security component and the prediction component to obtain the prediction module.

2. The method of claim 1, wherein the prediction component in S1) comprises a calling component and an execution component; wherein:
functions of the execution component comprise: a request function and a receiving function;
the request function for sending, through a function of the calling component, data for an input of the machine learning model to the machine learning model for calculation; and
the receiving function for receiving, through a function of the calling component, output data calculated by the machine learning model; and
functions of the calling component comprise: an encapsulation function and a decapsulation function;
the encapsulation function for encapsulating a format of the data for the input of the machine learning model into a format of data having configurations of a prediction interface; and
the decapsulation function for decapsulating the output data calculated by the machine learning model.

3. The method of claim 1, wherein acquiring the security component in S2) comprises:
selecting and configuring an authentication component and an anti-debugging component, and integrating the authentication component and the anti-debugging component into the security component.

4. The method of claim 1, before obtaining the prediction module in S2), comprising:
acquiring a decryption component matching pre-encryption of the machine learning model,
wherein integrating the security component and the prediction component comprises:
integrating the decryption component, the security component, and the prediction component.

5. The method of claim 1, in S2), after integrating the security component and the prediction component, and before obtaining the prediction module, further comprising:
obtaining an integrated component, performing obfuscated compilation on the integrated component, obtaining an execution file after the obfuscated compilation is completed, and packing the execution file.

6. The method of claim 1, wherein integrating the security component and the prediction component to obtain the prediction module in S2) comprises:
setting an execution rule, and integrating the security component and the prediction component in combination with the execution rule to obtain the prediction module; wherein,
the prediction module is configured to, based on an execution result of a function corresponding to the security component, selectively execute a function corresponding to the prediction component in combination with the execution rule.

7. A method for automatically generating a prediction service, comprising:
S1) selecting a machine learning model and acquiring interface configurations of the machine learning model; and
S2) selecting a prediction module adapted to the machine learning model based on metadata of the machine learning model, updating the prediction module in combination with the interface configurations, and assembling the machine learning model and the prediction module to generate the prediction service.

8. The method of claim 7, wherein S1) comprises:
S101) acquiring machine learning models to be trained with different types of metadata, training each machine learning model to be trained, defining interface configurations of each machine learning model to be trained, obtaining a set of pre-trained machine learning models after training is completed, and storing the set of pre-trained machine learning models in a model warehouse; and
S102) selecting a machine learning model from the model warehouse, and acquiring interface configurations of the machine learning model.

9. The method of claim 8, in S101), after acquiring the machine learning models to be trained with different types of metadata, and before defining the interface configurations of each machine learning model to be trained, further comprising:
configuring a preprocessor for each machine learning model to be trained; wherein
the preprocessor is configured to selectively change data for an input of the machine learning model to be trained based on a first preset rule, and to obtain data that meets input data requirements of the machine learning model to be trained after the change is completed.

10. The method of claim 8, wherein storing the set of pre-trained machine learning models in the model warehouse in S101) comprises:
pre-encrypting each pre-trained machine learning model in the set of pre-trained machine learning models, obtaining a set of pre-trained machine learning models with pre-encryption after the pre-encryption is completed, and storing the set of pre-trained machine learning models with pre-encryption in the model warehouse.

11. The method of claim 8, wherein S102) further comprises:
selecting a preprocessor based on the machine learning model; wherein,
the preprocessor is configured to selectively change data for an input of the machine learning model based on a second preset rule, and to obtain data that meets input data requirements of the machine learning model after the change is completed.

12. The method of claim 8, before updating the prediction module in combination with the interface configurations in S2), comprising:
S201) establishing prediction modules corresponding to the machine learning models to be trained or pre-trained machine learning models in the set of pre-trained machine learning models, and storing all the prediction modules in a prediction warehouse; and
S202) selecting the prediction module adapted to the machine learning model from the prediction warehouse based on the metadata of the machine learning model.

13. The method of claim 12, wherein establishing the prediction module in S201) comprises:
establishing the prediction module by an authentication component and an anti-debugging component.

14. The method of claim 10, wherein the prediction service in S2) has a decryption function that matches the pre-encryption of the machine learning model.

15. The method of claim 7, wherein assembling the machine learning model and the prediction module to generate the prediction service in S2) comprises:
assembling the machine learning model and the prediction module to generate a deployment piece of the prediction service, and installing the deployment piece in a production environment to generate an execution body of the prediction service in the production environment.

16. The method of claim 7, comprising:
activating the prediction service in a production environment;
acquiring an authorization state corresponding to an authentication function in the prediction service; and
in response to the authorization state meeting preset authentication conditions, decrypting the machine learning model of the prediction service in the production environment;
acquiring input data;
transmitting the input data to the machine learning model for calculation through an execution function and a calling function of the prediction service; and
obtaining, through the execution function and the calling function, output data and/or an output state calculated, based on the input data, by the machine learning model.

17. The method of claim 16, further comprising:
acquiring a debugging state corresponding to an anti-debugging function in the prediction service, and selectively activating a preset protection function in the prediction service based on a relationship between the debugging state and a preset debugging condition.

18. A system for automatically generating a prediction service, comprising:
a model warehouse, comprising at least one machine learning model;
a prediction warehouse, comprising at least one prediction module matching metadata of the machine learning model in the model warehouse; and
a processing engine, configured to have a function of assembling the machine learning model in the model warehouse and the prediction module in the prediction warehouse;
wherein the prediction module is configured to have an authentication function and an anti-debugging function, and the processing engine is configured to assemble the machine learning model in the model warehouse and the prediction module in the prediction warehouse which have a metadata matching relationship, and to generate the prediction service after the assembly is completed.
